(19) United States
(12) Patent Application Publication
(10) Pub. No.: US 2007/0070132 A1
(43) Pub. Date: Mar. 29, 2007

(54) INKJET DELIVERY MODULE

(76) Inventors: Fan-Cheung Sze, San Jose, CA (US); Quanyuan Shang, Saratoga, CA (US); Shinichi Kurita, San Jose, CA (US)

Correspondence Address: DUGAN & DUGAN, PC, 55 SOUTH BROADWAY, TARRYTOWN, NY, 10591, US

(21) Appl. No.: 11/535,475

(22) Filed: Sep. 26, 2006

Related U.S. Application Data
(60) Provisional application No. 60/721,340, filed on Sep. 27, 2005.

(51) Int. Cl. B41J 2/175

(52) U.S. Cl. 347/85

(57) ABSTRACT

A cabinet for housing an ink supply is provided for use with an inkjet printing system. The cabinet, ink supply, and related structures are set apart from inkjet print heads in the inkjet printing system. Accordingly, the cabinet provides a location to store and supply quantities of ink and may make service and replacement of parts and/or consumables simpler and more accessible. The cabinet also houses components used to process and/or supply ink to inkjet print heads such as solvent, fluid delivery mechanisms (e.g., pumps, gas pressure devices, etc.), tubes, sensors, filters, exhaust, and drainage.

### RELATED APPLICATIONS

The present application claims priority to U.S. Provisional Patent Application Ser. No. 60/721,340, filed Sep. 27, 2005 and entitled “INKJET DELIVERY MODULE”, (Attorney Docket No. 10145/L) which is hereby incorporated herein by reference in its entirety for all purposes.

This application is related to U.S. patent application Ser. No. 11/061,122, filed Feb. 8, 2005 and entitled “Methods and Apparatus for Reducing Ink Conglomerates during Inkjet Printing for Flat Panel Display Manufacturing”, (Attorney Docket No. 9704) which is incorporated herein by reference in its entirety.

### FIELD OF THE INVENTION

Embodiments of the present invention generally relate to substrate processing apparatuses and methods, such as apparatuses and methods for flat panel display processing apparatuses (e.g., LCD, OLED, and other types of flat panel displays), semiconductor wafer processing, solar panel processing, etc.

### BACKGROUND

Inkjet printing systems and their associated ink delivery systems may include numerous interrelated systems and apparatus that are complex and involve a substantial number of interconnections. Access to these various systems and apparatus for calibration, maintenance, and/or to replace consumable components may be difficult. Accordingly, methods and apparatus for organizing, containing, and relating these systems is needed.

### SUMMARY OF THE INVENTION

In some aspects of the invention, an apparatus for use with an inkjet delivery system is provided. The apparatus may comprise an enclosure disposed remotely from an inkjet printer, a plurality of ink reservoirs disposed within the enclosure, and at least one fluid delivery mechanism disposed within the enclosure and adapted to move ink from the ink reservoirs to a plurality of inkjet print heads at the inkjet printer.

In other aspects of the invention, a method of transferring ink to an inkjet print head in an inkjet printing system comprising pumping the ink from an ink reservoir to the inkjet print head, wherein the ink reservoir is disposed within an enclosure disposed remotely from the inkjet printing system may be provided.

In still other aspects of the invention, an inkjet delivery system may be provided. The system may comprise an inkjet printer which may have a plurality of inkjet print heads. The system may also have an ink delivery module disposed remotely from the inkjet printer comprising an enclosure, a plurality of ink reservoirs disposed within the enclosure, and at least one fluid delivery mechanism disposed within the enclosure and adapted to move ink from the ink reservoirs to the plurality of inkjet print heads.

Other features and aspects of the present invention will become more fully apparent from the following detailed description, the appended claims and the accompanying drawings.

### BRIEF DESCRIPTION OF THE DRAWINGS

FIG. 1A illustrates a perspective view of an inkjet printing system according to the present invention.

FIG. 1B illustrates a front schematic view of an embodiment of an ink delivery module according to the present invention.

FIG. 2A illustrates a detailed schematic view of an embodiment of an ink delivery module according to the present invention.

FIG. 2B illustrates a schematic view of inkjet print heads and associated hardware that may be used in conjunction with the present invention.

FIG. 3 depicts a schematic diagram of a portion of an embodiment of the present invention.

FIG. 4 depicts a block diagram of an exemplary method of ink travel in an enclosure used in the present invention.

### DETAILED DESCRIPTION

The present invention provides methods and apparatus for delivery of ink from an Ink Delivery Module to inkjet print heads. According to the present invention, a cabinet for housing an ink supply may be provided for use with an inkjet printing system. The cabinet, ink supply, and related structures may be set apart from inkjet print heads in the inkjet printing system. Accordingly, the cabinet may provide a location to store and supply quantities of ink and may make service and replacement of parts and/or consumables simpler and more accessible. The cabinet of the present invention may also house components used to process and/or supply ink to inkjet print heads such as solvent, fluid delivery mechanisms (e.g., gas pressure devices, pumps, etc.), tubes, sensors, filters, exhaust, and drainage. Providing these and other components in an enclosure apart from the inkjet print heads may allow increased organization and control over the processing and flow of ink prior to use in the inkjet printing system.

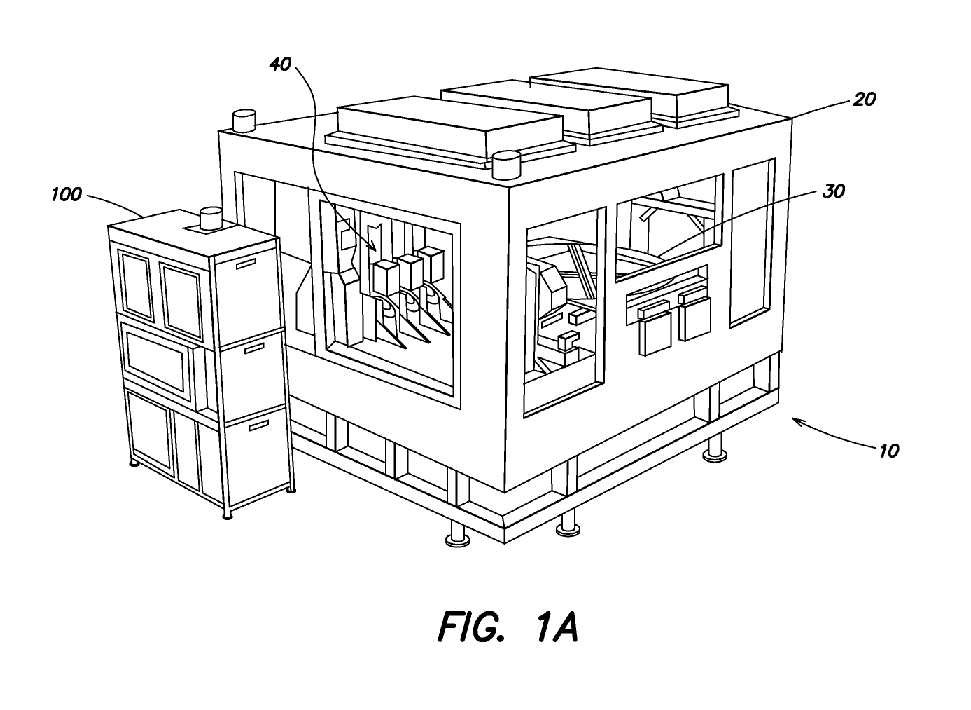

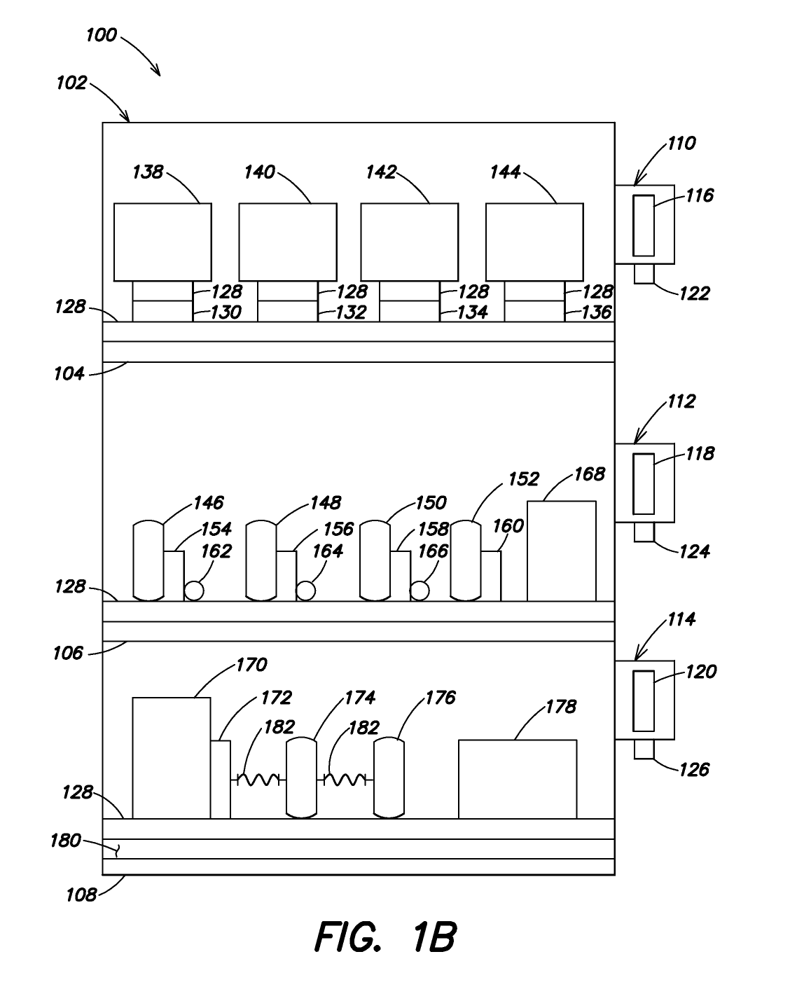

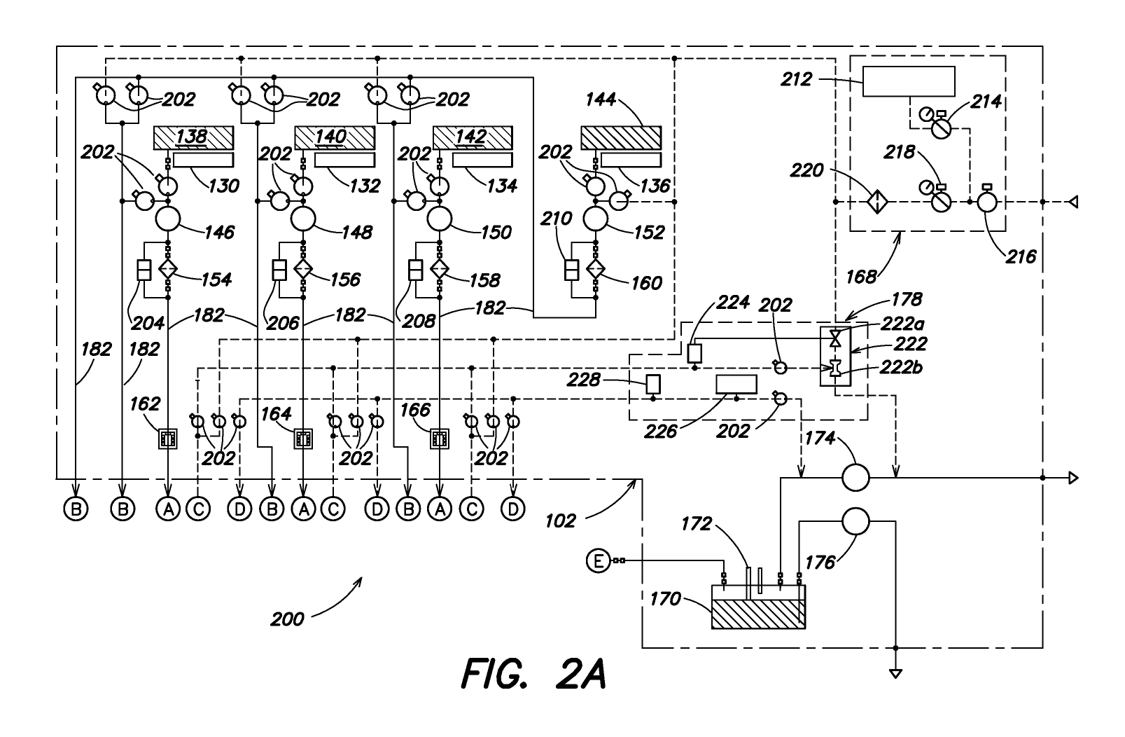

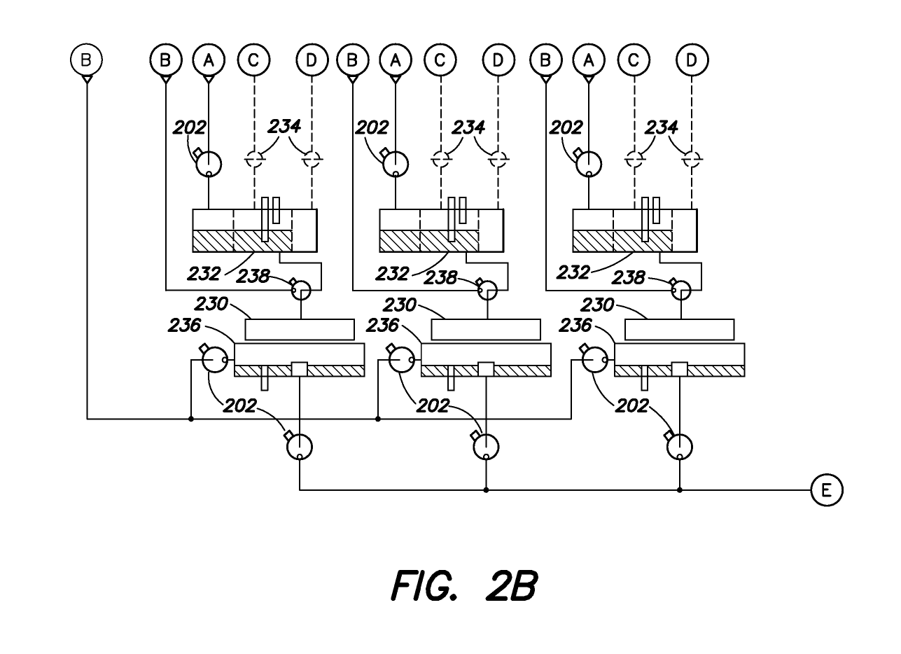

FIG. 1A illustrates a perspective view of an inkjet printing system according to the present invention. The inkjet printing system 10 may include an inkjet printing enclosure 20, which may provide a clean environment for inkjet printing. Enclosed in inkjet printing enclosure 20 may be inkjet station 30. Inkjet station 30 may provide means for (e.g., motors) positioning inkjet print head assembly 40. Inkjet print head assembly 40 may include one or more inkjet print heads 236 (described below in relation to FIG. 2B). Coupled to (e.g., in fluid communication and/or electrically) the inkjet printing system enclosure 10 may be Ink Delivery Module 100 (described in detail in FIG. 1B). Interaction between the Ink Delivery Module 100 and the components of inkjet printing system 10 are discussed in detail with relation to FIGS. 1B, 2A, and 2B.

FIG. 1B illustrates a front schematic view of an embodiment of an Ink Delivery Module according to the present invention, which is designated generally by the reference numeral 100. The Ink Delivery Module 100 of the present invention, in an exemplary embodiment, may include an enclosure 102, which may include shelves 104, 106, and 108. Coupled to the enclosure 102 may be doors 110, 112, and 114. Doors 110-114 may include windows 116, 118, and 120 and/or door close sensors 122, 124, and 126. Shelves 104-106 may each support a leak sensor 128.

Supported on shelf 104 may be one or more scales 130, 132, 134, and 136. Scales 130-136 may in turn each support a leak sensor 128. Also supported on scales 130-134 may be one or more ink reservoirs 138, 140, and 142. Scale 136 may support a solvent reservoir 144 similarly.

Supported on shelf 106 and coupled to ink reservoirs 138-142 may be ink pumps 146, 148, and 150, respectively. Similarly, a solvent pump 152 may be coupled to the solvent reservoir 144 and may be supported on shelf 106. Coupled respectively to the ink pumps 146-150 and also supported on shelf 106 may be ink filters 154, 156, and 158. A solvent filter 160 may be supported on shelf 106 and coupled to solvent pump 152. Ink filters 154-158 may each have a sonicator 162, 164, and 166 respectively coupled thereto. Sonicators 162-166 may additionally be supported on shelf 106. Also supported on shelf 106 may be a purge control unit 168.

Supported on shelf 108 may be a drain tank 170, which may include a drain tank level sensor 172. Coupled to drain tank 170 and supported on shelf 108 may be an exhaust pump 174 and a drain pump 176. An ink head pressure center 178 may also be supported on shelf 108. Above or beneath shelf 108 may be a spill pan 180. Tubes 182 may connect components in fluid connection with each other in enclosure 102.

In the exemplary embodiment of FIG. 1B, the enclosure 102 may be constructed of a sturdy material (e.g., steel sheet metal) in a manner that prevents leakage to the environment outside the enclosure 102. Shelves 104-108 and doors 110-114 may be constructed of similar materials. Windows 116-120 may be constructed of a fire resistant window material.

Leak sensors 128 may be any type of sensor capable of detecting fluid leakage. For example, an optical liquid leak detector may be used.

Scales 130-136 may be capable of detecting any range of mass, preferably measuring about six to ten kilograms of liquid ink and/or solvent. Scales 130-136 will preferably have high resolution (e.g., less than 0.1 grams) and linearity (e.g., +/−0.1 grams), though any appropriate resolution and/or linearity may be used.

Ink reservoirs 138-142 and solvent reservoir 144 preferably are of sufficient size to require refill or replacement about every two to seven days, though any appropriate capacity (e.g., 1, 2, 3, 4, 5, 6, etc. liter) or shape (e.g., cube, bottle, sphere, etc.) container may be used.

Ink pumps 146-150 are preferably peristaltic pumps, though any appropriate type of pump may be used. In a particular non-limiting embodiment, an ink pump that is capable of a flow speed of about 1-5 cc/sec with a flow pressure of about 6+/−1 PSI at the inkjet print head may be used. Other pumps with different flow speeds, flow pressures, and/or other performance characteristics may be used.

Solvent pump 152 is preferably a diaphragm pump, though any appropriate type of pump may be used. In a particular non-limiting embodiment, a pump capable of a flow speed of about 10 cc/sec with a flow pressure of about 6+/−1 PSI at the inkjet print head may be used. Other pumps with different flow speeds, flow pressures, and/or other performance characteristics may be used.

Ink filters 154-158 and solvent filter 160 preferably are capable of filtering particles of about 1 micron in size or larger, though filters capable of filtering larger or smaller particles may be used as appropriate. Filters 154-158 may be constructed of any suitable material, such as Teflon®, polypropylene, or nylon. Ink filters 154-158 and solvent filter 160 may, in some embodiments, be quick replacement filters.

Sonicators 162-166 may be any sonic processor, such as a megasonic processor, an ultrasonic processor, or a processor designed to act in another frequency range.

Drain tank 170 may be constructed of any suitable material (e.g., stainless steel) and preferably has a capacity of at least about 10 liters and may maintain a pressure of about less than 100 Torr. Other materials, capacities, or pressures may be used when appropriate. Drain tank level sensor 172 may be any sensor capable of detecting a level in the drain tank 170, such as a capacitance sensor.

Exhaust pump 174 is preferably a diaphragm pump, though any appropriate type of pump may be used. In a particular non-limiting embodiment, a pump capable of a flow speed of about more than 15 slm with a base pressure of about less than 100 Torr may be used. Other pumps with different flow speeds, base pressures, and/or other performance characteristics may be used. Ink head pressure center 178 may be capable of maintaining a negative pressure of between about 0 to 5″ H₂O, though any appropriate pressure may be used.

Spill pan 180 may be of sufficient size to contain any spilled material, preferably with a minimum depth of about two inches and able to contain at least about 110% of the contents of an ink reservoir 138-142.

Tubes 182 may be constructed of a sturdy material resistant to corrosion, such as Teflon®, though any appropriate material may be used. They may be of a dark color, such as black, to provide UV protection. Tubes 182 for use with pneumatic lines may also be constructed of nylon or a similar material.

In operation, enclosure 102 may be a cabinet or similar structure that may include one or more shelves 104-108. Shelves 104-108 may be capable of supporting any number of components for use in conjunction with an inkjet printer. Though three shelves 104-108 are shown in FIG. 1B, it is noted that any appropriate number of shelves may used to divide, support, and contain any components in enclosure 102. Shelves 104-108 may be positioned horizontally with components situated above or below the shelves 104-108 or may be positioned at any other angle. Enclosure 102 may preferably be capable of functioning as an exhausted enclosure. That is, enclosure 102 may be sealable in a manner that will prevent materials (e.g., ink, solvent, gases) from leaking out of the enclosure.

Access to the sealed enclosure 102 may be gained through one or more doors 110-114. Doors 110-114 may be attached to or hinged to enclosure 102 and/or may be removable. Any number of doors 110-114 may be used for access to enclosure 102 and may be sectioned or hinged in manners that allow access to a portion of enclosure 102 without compromising the seal of the remaining portion of the enclosure 102. In the exemplary embodiment of FIG. 1B, door 110 may provide access to replace ink and/or solvent in ink reservoirs 138-142 and solvent reservoir 144. Door 112 may provide access for maintenance of pumps 146-152 and/or purge control 168. Similarly, door 114 may provide access for maintenance of drain tank 178. As discussed above, any number of doors may be used to gain access to enclosure 102 and may provide for and/or support sealed portions of the enclosure 102.

Doors 110-114 may each include one or more windows 116-120 for monitoring components inside exhausted enclosure 102. Any appropriate number and location of windows may be used to monitor system performance (e.g., pump motion, scales, ink and/or solvent levels, drain tank condition, etc.). To ensure closure of doors 110-114 and/or sealing of enclosure 102, the Ink Delivery Module 100 may include one or more door close sensors 122-126. Door close sensors 122-126 may be capable of detecting various alarm conditions. For example, door close sensors 122-126 may detect any of doors 110-114 ajar or open and/or materials (e.g., fluids and/or gases) escaping enclosure 102 at or about doors 110-114.

Enclosure 102 may house any number of leak sensors 128, preferably at least seven (as described below). Leak sensors 128 may be located on each of shelves 104-108, beneath each of ink reservoirs 138-142 and solvent reservoir 144, and/or any location within enclosure 102 where fluids may leak. Though discussed herein as being disposed on shelves 104-108 and beneath reservoirs 138-144, one or more leak sensors 128 may be positioned below shelves 104-108, in reservoirs 138-144, or any other suitable location.

Scales 130-136 may support ink reservoirs 138-142 and/or solvent reservoir 144 and may serve to indicate the amount of ink and/or solvent used. For example, if ink reservoir 138 filled to a four-liter capacity sits atop scale 130, the scale 130 may be calibrated to only display the weight of the liquid in ink reservoir 138. As the ink is pumped from the ink reservoir 138, scale 130 may display a decreasing weight corresponding to the amount of ink remaining in ink reservoir 138. Scales 132-136 may operate similarly. In an alternative embodiment, scales 132-136 may be calibrated so as to display the weight of the container and any materials contained within it.

One or more ink reservoirs 138-142 may be capable of containing ink to be dispensed from an inkjet print head 230 (shown in FIG. 2B). Ink reservoirs 138-142 may each contain a separate color ink (for example, ink reservoir 138 may contain blue ink, ink reservoir 140 may contain green ink, ink reservoir 142 may contain red ink) or may all contain the same color ink. Though depicted in FIG. 1B as independent reservoirs, ink reservoirs 138-142 may be an integrated or otherwise attached unit.

Solvent reservoir 144 may be adapted to contain a solvent (e.g., PGMEA, acetone, or the like) for use in inkjet printing. Solvent reservoir 144 may be in fluid communication with ink reservoirs 138-142, inkjet print heads 230 (shown in FIG. 2B), or any other lines and/or components in the inkjet printing system and/or inkjet delivery module 100. Solvent from solvent reservoir 144 may be used to purge lines and/or components associated with the inkjet printing system subsequent to replacement of tubes and/or components (e.g., print heads 230 of FIG. 2B). In such embodiments, the solvent may be purged via a purge gas (e.g., N2, H2, filtered air, or the like).

Ink may be pumped from ink reservoirs 138-142 by corresponding ink pumps 146-150. In alternative embodiments, any number of ink pumps 146-150 may be used (e.g., a single pump for all ink reservoirs 146-150). Ink pumps 146-150 may be peristaltic pumps, or may be any other pump capable of pumping ink from ink reservoirs 138-142 to inkjet print heads 230 (shown in FIG. 2B).

Ink pumped from ink reservoirs 138-142 by pumps 146-150 may be pumped through respective ink filters 154-158. Ink filters 154-158 may filter particulate matter from the ink.

Ink pumped from ink reservoirs 138-142 by pumps 146-150 may also be flown through sonicators 162-166. Sonicators 162-166 may be capable of breaking up or dissolving particulate matter in ink transferred from ink reservoirs 138-142. Devices which may be used as sonicators 162-166 are described in pending U.S. patent application Ser. No. 11/061,122 titled “Methods and Apparatus for Reducing Ink Conglomerates during Inkjet Printing for Flat Panel Display Manufacturing” filed Feb. 8, 2005, which is incorporated herein by reference in its entirety. Alternatively, sonicators 162-166 may be coupled at other locations, such as directly coupled to the ink reservoirs 138-142 so as to reduce ink conglomerates therein. In an exemplary embodiment, an ultrasonic device may be used to break apart conglomerates in ink from ink reservoirs 138-142.

The purge control unit 168 may be coupled in a manner to allow ink and/or solvent to be purged from any or all components contained in the enclosure 102 or coupled thereto (e.g. inkjet print heads 230 operating outside the enclosure 102). The purge control unit 168 may assist in flowing a gas to one or more components contained within enclosure 102.

The drain tank 170 may be adapted to receive fluids and/or gasses flowed from components inside enclosure 102 and may be further adapted to receive fluids and/or gasses from outside enclosure 102. The drain tank 170 may serve as a holding tank to contain these fluids and/or gasses until they are transferred to a supporting system (e.g., an exhaust system or a drain facility that services a larger portion of the processing facility, such as a house exhaust system). In one or more embodiments, the drain tank 170 may be removable so that it may be drained of its contents and/or replaced with another drain tank 170.

To determine the level of fluids contained in drain tank 170, a drain tank level sensor 172 may be coupled thereto. In an exemplary embodiment, the drain tank level sensor may be capable of determining a level of fluids within the drain tank 170 and displaying the current level at the drain tank 170. In the same or alternative embodiments, the drain tank level sensor may be capable of determining the level of fluids in the drain tank 170 and relaying the level to an entity outside the enclosure 102 (e.g., a control panel, an external level indicator, a remote meter, etc.). In still other embodiments, the drain tank level sensor 172 may be adapted to cause an alarm to be triggered when the level of fluids in the drain tank 170 exceeds a pre-set level.

The exhaust pump 174 may be adapted to pump exhaust from the drain tank 170. In an exemplary embodiment, the exhaust pump 174 may be coupled to the drain tank 170 and be capable of pumping gasses contained within the drain tank 170 outside of enclosure 102 (e.g., pumping gasses to a house exhaust system).

The drain pump 176 may be similarly coupled to the drain tank 170. In an exemplary embodiment, the drain pump 176 may be coupled to the drain tank 170 and be capable of pumping fluids contained within the drain tank 170 outside of enclosure 102 (e.g., pumping fluids to a drain facility).

The ink head pressure center 178 may be adapted to provide a negative pressure at inkjet print heads 230 (FIG. 2B). That is, the ink head pressure center 178 may provide sufficient suction to prevent ink in inkjet print heads 230 (FIG. 2B) from leaking or flowing unintentionally.

The spill pan 180 may be adapted to contain fluids that spill, leak, or are otherwise deposited within enclosure 102. In an exemplary embodiment, the spill pan 180 may be removable from enclosure 102 for drainage and/or replacement. In the same or alternative embodiments, spill pan 180 may be removable from enclosure 102 without tampering with the seal of the exhausted enclosure as described above.

Tubes 182 may fluidly connect components within enclosure 102 and/or may provide fluid connection to components outside of enclosure 102 (e.g., the inkjet print heads 230 of FIG. 2B). In an exemplary embodiment, tubes 182 may fluidly connect ink reservoirs 138-142 with inkjet print heads 230 (FIG. 2B) through ink pumps 146-150, ink filters 154-158, and/or sonicators 162-166. In the same or alternative embodiments, tubes 182 may fluidly connect solvent reservoir 144 with ink reservoirs 138-142. In still other embodiments, tubes 182 may provide fluid connection of the ink head pressure center 178 with inkjet print heads 230 (FIG. 2B) and/or purge control unit 168. Similarly, purge control unit 168 may be fluidly connected via tubes 182 with ink reservoirs 128-142, solvent reservoir 144, or any other component within enclosure 102.

FIG. 2A illustrates a more detailed schematic view of an embodiment of an ink delivery module according to the present invention, which is designated generally by reference numeral 200. The ink delivery module of the present invention, in an exemplary embodiment, may include the components described above with reference to FIGS. 1A and 1B. Accordingly, description of these components is not repeated with reference to FIG. 2A.

As shown in FIG. 2A, enclosure 102 may also include control valves 202 coupled to tubes 182. Ink differential pressure sensors 204, 206, and 208 may be coupled in parallel with ink filters 154-158. Similarly, solvent differential pressure sensor 210 may be coupled in parallel with solvent filter 160.

In operation, ink from ink reservoirs 138-142 may be flowed through a set of control valves 202, pumped by ink pumps 146-150. Control valves 202 may be adapted to control the flow of ink and/or other material through tubes 182. Similarly, solvent and/or other flushing fluids from solvent reservoir 144 may be flowed through a control valve 202, pumped by solvent pump 152. The control valve 202 may be adapted to control the flow of solvent and/or other material through tubes 182. Here, solvent from solvent reservoir 144 may be passed through further control valves 202 and flowed into tubes 182 (e.g., to flush ink). Ink and/or solvent may be pumped through ink pumps 146-150. In alternative embodiments, solvent may be flowed into the ink stream at another point (e.g., at the inkjet print heads 230 of FIG. 2B and/or directly into ink reservoirs 138-142).

Ink and/or solvent may then be flowed through the ink filters 154-158 and/or ink differential pressure sensors 204-208. In an exemplary embodiment, ink filters 154-158 and ink differential pressure sensors 204-208 are arranged in parallel. Alternatively, ink filters 154-158 and ink differential pressure sensors 204-208 may be arranged in series. Ink differential pressure sensors 204-208 may be adapted to measure the pressure of ink and/or solvent flow at two points in a tube 182 and use these measurements to sense a difference in pressure.

In a similar manner, solvent flowed from solvent reservoir 144 may be flowed through the solvent filter 160 and/or solvent differential pressure sensor 210. In an exemplary embodiment, solvent filter 160 and solvent differential pressure sensor 210 are arranged in parallel. Alternatively, solvent filter 160 and solvent differential pressure sensor 210 may be arranged in series. Solvent differential pressure sensor 210 may be adapted to measure the pressure of solvent flow at two points in a tube 182 and use these measurements to sense a difference in pressure.

Ink and/or solvent may then be pumped to components outside the enclosure 102 through lines A, for example. Solvent and/or a flushing fluid may be pumped to components outside the enclosure 102 through lines B, for example.

Purge control unit 168, depicted in FIG. 1B, is shown in greater detail in FIG. 2A. The purge control unit 168 may include a valve assembly 212 coupled to a first regulator 214. The first regulator 214 may be coupled to a manual valve 216 and a second regulator 218. The second regulator 218 may in turn be coupled to a purge filter 220.

In an exemplary embodiment, valve assembly 212 may provide an increased pressure to a gas to be flowed to the first regulator 214. The valve assembly 212 may be any appropriate valve capable of helping to increase pressure, such as a solenoid pilot valve.

The first regulator 214 may be adapted to control the pressure applied by the valve assembly 212. In an exemplary embodiment, the first regulator 214 may hold gas flowed through a tube (not shown in FIG. 2A; see tubes 182 in FIG. 1B) at about 70 psi, although any appropriate pressure may be used.

A purge gas (e.g., N2, H2, filtered air, or the like) may be flowed from an outside source through manual valve 216, which may be capable of controlling the gas flow from the outside source. The manual valve 216 may have lockout and/or tagout capability. A purge gas flowed through manual valve 216 and gas received from the first regulator 214 may be further regulated by the second regulator 218. In an exemplary embodiment, the second regulator 218 may hold gas flowed through a tube (not shown in FIG. 2A; see tubes 182 in FIG. 1B, for example) at about 5 psi, although any appropriate pressure may be used.

After passing through the second regulator 218, the purge gas may be passed through a purge filter 220, which may filter the purge gas. In an exemplary embodiment, the purge filter 220 may be capable of filtering particulates from the purge gas of about 0.1 um or more. After being filtered by purge filter 220, the purge gas may be flowed through tubes (not shown in FIG. 2A; see tubes 182 in FIG. 1B, for example) to various components contained within the enclosure 102 (e.g., to clear ink and/or solvent from tubes 182) and/or to components outside enclosure 102 (e.g., to clear inkjet print heads 230 in FIG. 2B).

Purge gas may also be flowed to ink head pressure center 178. The ink head pressure center 178 of FIG. 1B is included in FIG. 2A in greater detail. Ink head pressure center 178 may include a meniscus pressure center 222, which may include a control valve 222a and/or a venturi 222b, coupled to a meniscus sensor 224 and a flow control valve 202.

The meniscus pressure center 222 may be capable of receiving the purge gas from the purge control unit 168 and causing a negative pressure at inkjet print heads 230 (shown in FIG. 2B). In an exemplary embodiment, the meniscus pressure center 222 may be capable of causing a negative pressure of about 0-5″ H₂0 at the inkjet print heads 230. In the same or other embodiments, the meniscus pressure center is further capable of controlling each inkjet print head independently. In at least one embodiment, the meniscus pressure center 222 may be coupled to a meniscus sensor 224, which may be capable of sensing a pressure of between about 0″ and 5″ H₂0. The meniscus sensor 224 may provide feedback to the meniscus pressure center 222 at the control valve 222a. The control valve 222a may be capable of controlling the flow rate of gas flowed through it. This gas may be pumped from the purge control unit 168 to the meniscus pressure center 222 at control valve 222a and through the venturi 222b, to components outside enclosure 102, for example.

To assist in applying a negative pressure to the inkjet print heads 230 (FIG. 2B), the enclosure 102 may also house a meniscus vacuum 226 coupled to a vacuum sensor 228 and a flow control valve 202. The meniscus vacuum 226 may be adapted apply suction so as to cause a negative pressure at the components outside enclosure 102 (e.g., the meniscus vacuum 226 may apply suction to the inkjet print heads 230 through lines D). In an exemplary embodiment, the meniscus vacuum 226 may be capable of a pressure of about 200 Torr, though a vacuum capable of any appropriate pressure may be used. The vacuum sensor 228 may measure appropriate pressure.

FIG. 2B illustrates a schematic view of inkjet print heads 230 and associated hardware (which may be enclosed in inkjet printing enclosure 20 of FIG. 1A) that may be used in conjunction with the present invention. Coupled to inkjet print heads 230 may be inkjet reservoirs 232. Inkjet reservoirs may each be coupled to any number of filters 234. Inkjet print heads may reside at head stations 236. Coupled between print heads 230 and inkjet reservoirs 232 may be 3-way valves 238.

Used in concert with the enclosure 102 of FIGS. 1B and 2A, inkjet print heads 230 may be directly or indirectly supplied ink and/or solvent through lines A and solvent through lines B. For example, ink and/or solvent may be flowed from the enclosure 102 through lines A into inkjet reservoirs 232, which may hold a quantity of ink and/or solvent until it is consumed by inkjet print heads 230.

To assist the inkjet print heads 230 in operation, a negative pressure may be employed at the inkjet print heads 230 to prevent ink from leaking and/or being inadvertently discharged. In order to achieve such a negative pressure, gas may be flowed from the enclosure 102 through lines C into inkjet reservoirs 232. The gas may be passed through one or more filters 234 which may filter any particulate matter from the gas stream. Filters 234 may be quick replacement filters. At the same time, suction may be applied through lines D at inkjet reservoirs 232. One or more filters 234 may also filter gas flowing through lines D from inkjet reservoirs 232. The flow of gas and suction may be adjusted so as to generate a negative pressure at the inkjet print head sufficient so as to deter ink leakage.

Additionally or alternatively, when 3-way valves are employed between inkjet print heads 230 and inkjet reservoirs 232, the 3-way valves 238 may provide two supply paths to the inkjet print heads 230. The first supply path may include ink flowed from the inkjet reservoirs 232, which are used during normal inkjet printing operations. The second supply path may include a purge gas (e.g., nitrogen or filtered air) and/or a solvent (e.g., PGMEA) flowed to the 3-way valves 238 through lines B.

During a purge operation, ink inside inkjet print heads 230 may be purged by the purge gas and subsequently flushed with the solvent. The solvent may then remain in the inkjet print heads 230 until printing resumes to prevent clogging. To restart printing, the inkjet print heads 230 may be purged by the purge gas and/or solvent through 3-way valves 238 and subsequently supplied with ink from inkjet reservoir 230s through 3-way valves 238. In one embodiment, a long purge may be followed by a few short purges before printing resumes.

Should inkjet print heads 230 become clogged due to drying ink, the inkjet print heads 230 may be flushed by the purge gas and/or solvent to remove any solid deposit inside inkjet print heads 230. The purge gas may force open one or more nozzles (not shown) of inkjet print heads 230, allowing the solvent to access and dissolve any dried ink.

The 3-way valves 238 may be advantageous as they allow a gating to facilitate purging and unclogging of inkjet print heads 230. Purging and unclogging inkjet print heads 230 may improve the lifetime of the part, thus reducing system cost. Additionally, 3-way valves 238 may consume less space than an analogous system using two 2-way valves, thus reducing the footprint of the system.

When inkjet print heads 230 are in residence at head stations 236, any overflow, spilled, or otherwise excessive ink, solvent, and/or other fluids and/or gasses may be acquired and moved away from (e.g., pumped or siphoned from) the inkjet print heads 230. This ink or other material may be flowed though lines E to be deposited in drain tank 170 (FIGS. 1B and 2A).

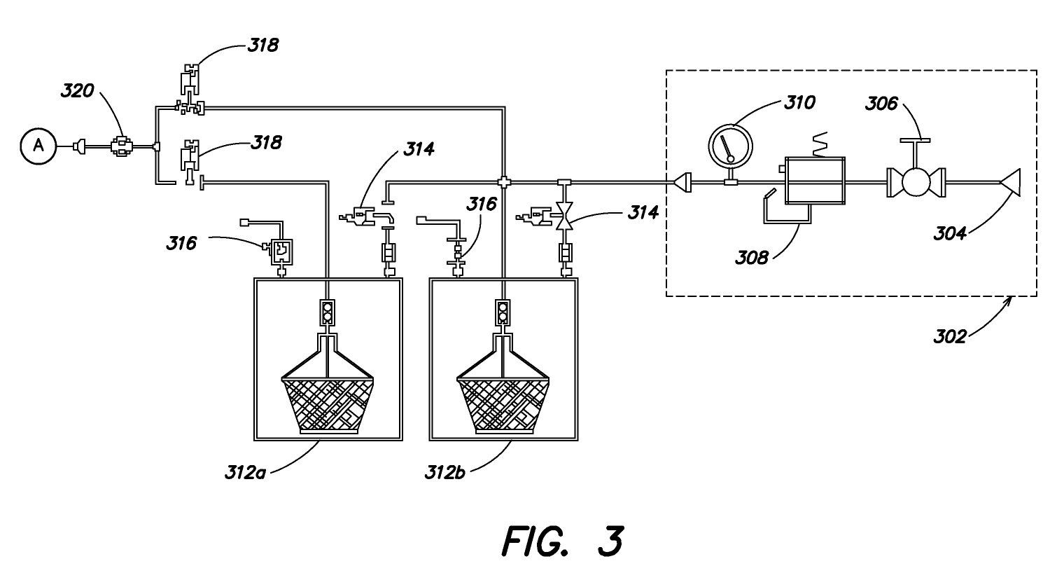

Other arrangements and/or methods and apparatus for conveyance may be used where appropriate including the addition of and/or elimination of certain components (e.g., pumps, valves, controllers, tubes, pressure devices, etc.) without departing from the scope of this invention. For example, in the alternative embodiment of FIG. 3, gas pressure may be used as a fluid delivery mechanism to move ink instead of the pumps depicted in FIGS. 1B and 2A. The ink delivery module of the present invention, in an exemplary embodiment, may include the components described above with reference to FIGS. 1B and 2A. Accordingly, description of these components is not repeated with reference to FIG. 3. Similarly, components ancillary to the particular workings of the embodiment of FIG. 3 are omitted for clarity. It is understood that these components (e.g., scales, valves, gauges, filters, etc.) depicted in FIGS. 1B and 2A may be used in the embodiment of FIG. 3 in any appropriate manner.

FIG. 3 depicts a schematic diagram of a portion of an embodiment of the present invention including a preferable fluid delivery mechanism. A purge gas (e.g., air, N2, etc.) may be flowed from a supply center 302, which may comprise a gas supply 304, a shut-off valve 306, a pressure control device 308, and a gauge 310. Gas from supply center 302 may be flowed to ink reservoirs 312a and 312b through valves 314. Reservoirs 312a-b may be vented via check valves 316. Ink from ink reservoirs 312a-b may be flowed through valves 318 and past flow meter 320.

Supply center 302 may be similar to, component of, and/or replacement for purge control unit 168 of FIG. 2A. Gas supply 304 may be any appropriate supply including a house gas system or gas tank. Shut-off valve 306 may be a ball valve, a valve such as valve 206 discussed above with respect to FIG. 2A, or any other appropriate valve.

Ink reservoirs 312a-b may be similar to, component of, and/or replacement for ink reservoirs 138-142 of FIGS. 1B and 2A. Reservoirs 312a-b may contain the same color ink and may be used simultaneously, alternately, or in replacement of one another. Though depicted here as two reservoirs, it is understood that any number of reservoirs (e.g., 1, 3, 4, 5, etc.) may be used and the reservoirs 312a-b may contain one or more colors of ink. In such cases where ink reservoirs 312a-b contain the same color ink, it is understood that each ink reservoir 312a-b may correspond to an individual print head 230 of FIG. 2B or may be used communally for multiple print heads.

In operation, fluid may be delivered via fluid delivery mechanisms. Specifically, a gas (e.g., hydrogen, nitrogen, filtered air, etc.) is flowed from the gas supply 304 of the supply center 302 through the shut-off valve 306, pressure control valve 308, and gauge 310 to the ink reservoirs 312a-b. The gas from the supply center 302 exerts a positive pressure on the ink reservoirs 312a-b. Gas pressure from the supply center 302 may be controlled and/or shut off via valves 314. Similarly, the pressure inside the reservoirs 312a-b may be controlled and/or exhausted using check valves 316.

The pressure exerted on the reservoirs 312a-b may cause ink to be flowed (e.g., via tubes 182 of FIGS. 1B and 2A) through valves 318 and past flow meter 320, which may be used to control and/or monitor ink flow pressure. Ink may then be flowed to the inkjet print heads 230 of FIG. 2B through line A (e.g., in the same way as in FIG. 2A), for example.

It may be understood that any appropriate gas pressure devices may be used as a fluid delivery mechanism. For example, the embodiment of FIG. 3 may utilize more or less valves, meters, sensors, etc. than described herein. Additionally, it may be understood that any other suitable arrangement wherein gas pressure is utilized to facilitate the flow of fluids within the above described systems and/or apparatus may be used.

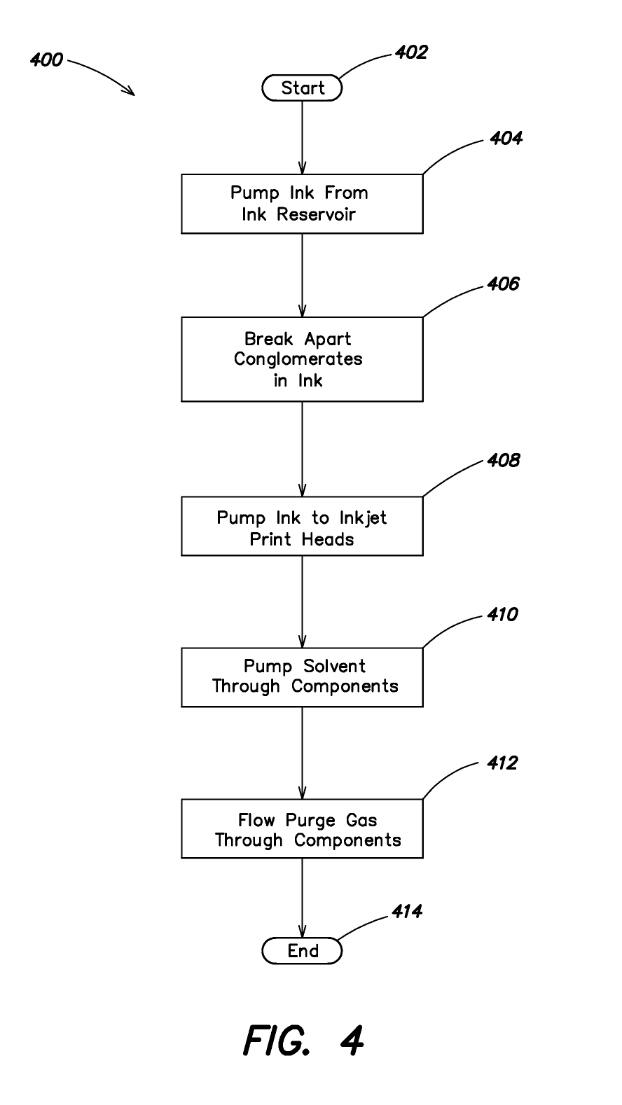

FIG. 4 depicts a block diagram of an exemplary method 400 of ink travel in an enclosure used in the present invention. The method begins at step 402.

In step 404, ink from ink reservoirs 138-142 may be pumped into tubes 182 by ink pumps 146-150. Each ink reservoir 138-142 may contain a different color ink. Accordingly, each ink reservoir 138-142 may pump into separate lines 182. Additionally or alternatively, the ink may be pumped from ink reservoirs 312a-b via gas pressure from gas supply center 302. In such embodiments, each reservoir 312a-b may supply the same color ink to lines 182. In alternative embodiments, any number of ink reservoirs (e.g., ink colors) may be used.

In step 406, ink may be flown through sonicators 162-166 to break apart any conglomerates in the ink. Sonication and methods for breaking apart conglomerates in ink and solvent are discussed above with reference to co-pending U.S. patent application Ser. No. 11/061,122 titled “Methods and Apparatus for Reducing Ink Conglomerates during Inkjet Printing for Flat Panel Display Manufacturing.” Any other appropriate method for breaking apart any particulate or conglomerate in the ink may be used.

In step 408, ink may be flowed outside the enclosure 102 to other components (e.g., inkjet print heads 230). Ink may be pumped to inkjet print heads 230 by ink pumps 146-150 and/or by pressure from gas supply center 302 as described with respect to FIG. 3. In the same or alternative embodiments, the negative pressure applied at the inkjet print heads 230 may act to suction ink from the enclosure 102 to the inkjet print heads 230 through lines A.

In step 410, solvent from solvent reservoir 144 is pumped via solvent pump 152 and/or by gas pressure from gas supply 302 through ink containing components (e.g., print heads 230, lines 182, etc.) to clean these components (e.g., after replacement of a tube or component).

In step 412, gas from gas supply 302 and/or purge control unit 168 is flown through the components and/or lines to purge solvent from the lines and/or components.

The method ends at step 414.

The foregoing description discloses only exemplary embodiments of the invention; modifications of the above disclosed methods and apparatus which fall within the scope of the invention will be readily apparent to those of ordinary skill in the art. For instance, although the above example system, as described above with reference to FIGS. 1A, 1B, 2A, and 3 provides for certain components to be contained within the enclosure 102 and arranged in an exemplary order, one of ordinary skill in the art will understand that this system may house any suitable components for use in inkjet printing which may be advantageously located apart from the inkjet print heads. Further, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

The invention claimed is:

1. An apparatus for use with an inkjet delivery system comprising:
an enclosure disposed remotely from an inkjet printer;
a plurality of ink reservoirs disposed within the enclosure; and,
at least one fluid delivery mechanism disposed within the enclosure and adapted to move ink from the ink reservoirs to a plurality of inkjet print heads at the inkjet printer.

2. The apparatus of claim 1 wherein the at least one fluid delivery mechanism is a pump.

3. The apparatus of claim 1 wherein the at least one fluid delivery mechanism comprises a gas supply adapted flow a gas into the plurality of ink reservoirs and to exert a pressure on the plurality of ink reservoirs.

4. The apparatus of claim 1 further comprising:
a solvent reservoir disposed within the enclosure, wherein the at least one fluid delivery mechanism is further adapted to pump solvent from the solvent reservoir to the plurality of inkjet print heads at an inkjet printer.

5. The apparatus of claim 1 further comprising:
a conglomerate-reducing device disposed within the enclosure and adapted to break apart conglomerates in the ink.

6. The apparatus of claim 1 further comprising:
an exhaust pump disposed within the enclosure and adapted to reclaim purged and spilled ink from the inkjet print head;
a drain tank disposed within the enclosure and adapted to contain reclaimed ink; and,
a drain pump disposed within the enclosure and adapted to dispose ink from the drain tank to a drain facility.

7. The apparatus of claim 4 further comprising:
an exhaust pump disposed within the enclosure and adapted to reclaim purged and spilled ink and solvent from the inkjet print head;
a drain tank disposed within the enclosure and adapted to contain reclaimed ink and solvent; and,
a drain pump disposed within the enclosure and adapted to dispose ink and solvent from the drain tank to a drain facility.

8. The apparatus of claims 2 or 4 wherein the at least one fluid delivery mechanism is a peristaltic pump.

9. The apparatus of claim 1 further comprising:
a meniscus vacuum disposed within the enclosure and adapted to maintain a negative pressure at the inkjet print head.

10. The apparatus of claim 1 further comprising:
an ink monitor disposed within the enclosure and adapted to monitor a flow of the ink from the ink reservoir to the inkjet print head.

11. The apparatus of claim 4 further comprising:
a solvent monitor disposed within the enclosure and adapted to monitor a flow of the solvent from the solvent reservoir to the inkjet print head.

12. A method of transferring ink to an inkjet print head in an inkjet printing system comprising:
pumping the ink from an ink reservoir to the inkjet print head, wherein the ink reservoir is disposed within an enclosure disposed remotely from the inkjet printing system.

13. The method of claim 12 further comprising:
pumping a solvent from a solvent reservoir to the inkjet print head, wherein the solvent reservoir is disposed within the enclosure disposed remotely from the inkjet printing system.

14. The method of claim 13 further comprising:
monitoring a flow of the ink from the ink reservoir to the inkjet print head;
monitoring a flow of the solvent from the solvent reservoir to the inkjet print head.

15. The method of claim 12 further comprising:
breaking apart conglomerates in the ink before the ink reaches the inkjet print head.

16. The method of claim 12 further comprising:
pumping reclaimed purged and spilled ink from the inkjet print head;
containing reclaimed ink in a drain tank disposed within the enclosure; and,
pumping ink from the drain tank to a drain facility.

17. The method of claim 13 further comprising:
pumping reclaimed purged and spilled solvent from the inkjet print head;
containing reclaimed solvent in a drain tank disposed within the enclosure; and,
pumping solvent from the drain tank to a drain facility.

18. The method of claim 12 further comprising:
maintaining a negative pressure at the inkjet print head.

19. The method of claim 12 wherein pumping the ink from an ink reservoir to the inkjet print head comprises:
flowing a gas into the ink reservoir, wherein the gas exerts pressure on an ink within the ink reservoir.

20. An inkjet delivery system comprising:
an inkjet printer comprising:
a plurality of inkjet print heads; and,
an ink delivery module disposed remotely from the inkjet printer comprising:
an enclosure;
a plurality of ink reservoirs disposed within the enclosure; and,
at least one fluid delivery mechanism disposed within the enclosure and adapted to move ink from the ink reservoirs to the plurality of inkjet print heads.

21. The inkjet delivery system of claim 20, wherein the inkjet print heads are connected to the ink delivery module via tubes.

22. The inkjet delivery system of claim 20 wherein the inkjet printer further comprises a plurality of reservoirs coupled to the inkjet print heads.

23. The inkjet delivery system of claim 22 wherein the reservoirs further comprise quick replacement filters.

24. The system of claim 20 wherein the at least one fluid delivery mechanism comprises a gas supply adapted flow a gas into the plurality of ink reservoirs and to exert a pressure on the plurality of ink reservoirs.
